(19) United States
(12) Patent Application Publication
(10) Pub. No.: US 2017/0350721 A1
(43) Pub. Date: Dec. 7, 2017

(54) Method of Updating All-Attitude Angle of Agricultural Machine Based on Nine-Axis MEMS Sensor

(71) Applicant: SHANGHAI HUACE NAVIGATION TECHNOLOGY LTD, Shanghai (CN)

(72) Inventors: Qiang REN, Shanghai (CN); Jiejun WANG, Shanghai (CN); Wending DAI, Shanghai (CN); Guangjie CAO, Shanghai (CN); Guangyang DONG, Shanghai (CN); Rui TU, Shanghai (CN)

(73) Assignee: SHANGHAI HUACE NAVIGATION TECHNOLOGY LTD, Shanghai (CN)

(21) Appl. No.: 15/538,201

(22) PCT Filed: Jul. 4, 2016
(86) PCT No.: PCT/CN2016/088316

§ 371 Date: Jun. 21, 2017

(30) Foreign Application Priority Data
Oct. 13, 2015 (CN) 201510664990.3

(51) Int. Cl. G01C 23/00; A01B 69/04; A01B 79/00; G01C 25/00

(52) U.S. Cl. CPC G01C 23/00; G01C 25/00; A01B 69/008; A01B 79/005

(57) ABSTRACT

A method of updating an all-attitude angle of an agricultural machine based on a nine-axis MEMS sensor includes the following steps: establishing an error model of a gyroscope, an electronic compass calibration ellipse model and a seven-dimensional EKF filtering model, and setting a parameter vector corresponding to a vehicle motional attitude (S1); acquiring data including an acceleration and an angular velocity of a motion of vehicle, and an geomagnetic field intensity in real time (S2); calculating an angle, a velocity, position information, and a course angle of the vehicle by established error model of the gyroscope and the electronic compass calibration ellipse model(S3); data-fusion processing the angle, the velocity, the position information and the course angle of the vehicle by the seven-dimensional EKF filtering model, and updating a motional attitude angle of the vehicle in real time. The steps of the method have a small error, high precision, and reliability.

### CROSS REFERENCE TO RELATED APPLICATIONS

This application is the national phase entry of International Application No. PCT/CN2016/088316, filed on Jul. 4, 2016, which is based upon and claims priority to Chinese Application No. CN201510664990.3, filed on Oct. 13, 2015, the entire contents of which are incorporated herein by reference.

### TECHNICAL FIELD

The invention relates to the measurement technology field, and particularly relates to a method of updating the all-attitude angle of the agricultural machine based on a nine-axis MEMS sensor.

### BACKGROUND

With the developments of MEMS (Micro-Electro-Mechanical-System) sensor technology, navigation technology, and control technology among others all support Chinese agriculture, which makes precision agriculture an increasingly popular trend. During machine assisted driving of agricultural machines, information regarding various aspects of the vehicle, including a pitch angle, a rolling angle and a course angle can provide important data inputs for a high precision integrated navigation and control algorithm.

Currently, the inertial navigation system includes PINS (Platform Inertial Navigation System) and SINS (Strapdown Inertial Navigation System). Compared to PINS, SINS uses IMU (Inertial Measuring Unit) sensors to establish a “mathematical platform” by calculation, so as to replace PINS. SINS is generally used in aircraft navigation control systems. However, in the field of agricultural machine control, research and application of SINS are still at an early stage. Furthermore, aircraft navigation control systems are significantly different from agricultural machine control in terms of the application objects and environmental conditions. The method of SINS implemented in aircraft navigation control systems cannot apply in the agricultural machine control.

### SUMMARY OF THE INVENTION

In view of the above-mentioned defects in applying inertial navigation in the agricultural machine, the invention provides a method of updating the all-attitude angle of an agricultural machine based on a nine-axis MEMS sensor, with small error, high precision, and reliability.

To achieve the objectives, the embodiments of the invention adopt the following technical solutions.

A method of updating an all-attitude angle of an agricultural machine based on a nine-axis MEMS sensor. The method of updating the all-attitude angle of an agricultural machine based on a nine-axis MEMS sensor includes the following steps:
establishing an error model of a gyroscope, an electronic compass calibration ellipse model and a seven-dimensional EKF filtering model, and setting a parameter vector corresponding to a vehicle motional attitude;
acquiring data including an acceleration and an angular velocity of a motion of vehicle, and a geomagnetic field intensity in real time by a nine-axis MEMS sensor;
calculating an angle, a velocity, position information, and a course angle of the vehicle by established error model of the gyroscope and the electronic compass calibration ellipse model, according to obtained data including the acceleration and the angular velocity of the motion of vehicle, and the geomagnetic field intensity;
data-fusion processing the angle, the velocity, the position information and the course angle of the vehicle by the seven-dimensional EKF filtering model, and updating a motional attitude angle of the vehicle in real time;
wherein the nine-axis MEMS sensor is composed of a three-axis gyroscope, a three-axis accelerometer, and a three-axis geomagnetic sensor.

According to one aspect of the present invention, the step of establishing an error model of a gyroscope, an electronic compass calibration ellipse model and a seven-dimensional EKF filtering model, and setting a parameter vector corresponding to a vehicle motional attitude is described in detail as below:
calculating the angular velocity of the gyroscope in the error model of the gyroscope via an error calculation formula of the gyroscope; wherein the error calculation formula of the gyroscope is: ω=ω_{ib}+b_{ωr}+b_{ωg}, wherein ω is an angular velocity output by the gyroscope, ω_{ib} is a real angular velocity of the gyroscope, b_{ωr} is a zero drift of the gyroscope, and b_{ωg} is a white noise output by the gyroscope;
eliminating a magnetic field interference by the electronic compass calibration ellipse model; wherein the electronic compass calibration ellipse model is:

$$\frac{{( mx - Xoffset )}^{2}}{{Xsf}^{2}} + \frac{{( my - Yoffset )}^{2}}{{Ysf}^{2}} = 1 ,$$

wherein mx, my are magnetic field intensities, Xoffset and Yoffset are hard magnetic interferences, and Xsf and Ysf are soft magnetic interferences;
updating the vehicle attitude by the seven-dimensional EKF filtering model, wherein, the seven-dimensional EKF filtering model uses an extended Kalman filter for a seven-dimensional state vector, and EKF includes a state equation and an observation equation:

\dot{x}=f(x,ω)+w1

y=h(x)+v1
wherein the state matrix is x=[q b_{ωr}], q is quaternion vectors q0, q1, q2, q3, and b_{ωr} is a zero drift of the XYZ three-axis gyroscope, wherein ω is the angular velocity output by the gyroscope, w1 is a process noise matrix, v1 is an observation noise matrix, y is an observation vector, y[a ψ_{mag}]^{T}, wherein a is a three-axis acceleration value, ψ_{mag} is a course angle calculated by the electronic compass,

$$f ( x , ω ) = [ \begin{matrix}\frac{1}{2} [ \begin{matrix}- {q}_{1} & - {q}_{2} & - {q}_{3} \\ {q}_{0} & - {q}_{3} & {q}_{2} \\ {q}_{3} & {q}_{0} & - {q}_{1} \\ - {q}_{2} & {q}_{1} & {q}_{0}\end{matrix} ] [ \begin{matrix}{ω}_{x} - {b}_{ω x} \\ {ω}_{y} - {b}_{ω y} \\ {ω}_{z} - {b}_{ω z}\end{matrix} ] \\ {0}^{3 \times 1}\end{matrix} ]$$

$$h = [ \begin{matrix}2 g ( {q}_{1} {q}_{3} - {q}_{0} {q}_{2} ) \\ 2 g ( {q}_{2} {q}_{3} + {q}_{0} {q}_{1} ) \\ g ( {q}_{0}^{2} - {q}_{1}^{2} - {q}_{2}^{2} + {q}_{3}^{2} ) \\ {tan}^{- 1} ( \frac{2 ( {q}_{1} {q}_{2} + {q}_{0} {q}_{3} )}{{q}_{0}^{2} + {q}_{1}^{2} - {q}_{2}^{2} - {q}_{3}^{2}} )\end{matrix} ] .$$

According to one aspect of the present invention, the step of acquiring data including an acceleration and an angular velocity of a motion of vehicle, and a geomagnetic field intensity in real time by a nine-axis MEMS sensor is described in detail as below:

obtaining the angular velocity of the vehicle through the gyroscope, and compensating the zero drift of the gyroscope;

acquiring acceleration data of the vehicle by an acceleration sensor; and
acquiring the geomagnetic field intensity of the vehicle by the geomagnetic sensor.

According to one aspect of the present invention, the step of calculating an angle, a velocity, position information, and a course angle of the vehicle by established error model of the gyroscope and the electronic compass calibration ellipse model, according to obtained data including the acceleration and the angular velocity of the motion of vehicle, and the geomagnetic field intensity is described in detail as below:

obtaining angle data by an integral calculation of the angular velocity by the error model of the gyroscope;

calculating the velocity by integrating the acceleration data, and the position information is calculated by further integrating the velocity; and

calculating the course angle of the vehicle from geomagnetic field intensity data which is compensated by a calibration parameter and corrected by an oblique angle, and both the calibration parameter and the oblique angle being calculated by the elliptical model.

According to one aspect of the present invention, the step of data-fusion processing the angle, the velocity, the position information and the course angle of the vehicle by the seven-dimensional EKF filtering model, and updating a motional attitude angle of the vehicle in real time is described in detail as below:
calculating attitude data of the vehicle by the seven-dimensional EKF filtering model, through a quaternion attitude updating algorithm, wherein, a calculation process of the EKF algorithm is as below:

$${\hat{x}}_{k} ( - ) = {Φ}_{k - 1} {\hat{x}}_{k} ( + )$$

$${Φ}_{k} = {e}^{\frac{\partial f}{\partial x}}$$

$${P}_{k} ( - ) = {Φ}_{k - 1} {P}_{k - 1} ( + ) {Φ}_{k - 1}^{T} + Q$$

$${\hat{x}}_{k} ( + ) = {\hat{x}}_{k} ( - ) + {K}_{k} \vert {y}_{k} - h ( {\hat{x}}_{k} ( - ) ) \vert$$

$${P}_{k} ( + ) = [ I - {K}_{k} {H}_{k} ] {P}_{k} ( - )$$

$${H}_{k} = \frac{\partial h}{\partial x} {\vert}_{k} \\ {K}_{k} = {P}_{k} ( - ) {H}_{k} [ {H}_{k} {P}_{k} ( - ) {H}_{k}^{T} + {R}_{k} ]$$

wherein k is a sampling time point, \hat{x}ₖ is a system state estimation, (−) is a previous time point, (+) is a later time point, Φₖ is a state transition matrix, Pₖ is a minimum mean square error matrix, Q is a covariance matrix corresponding to the state vector, Kₖ is an error gain, yₖ is an observation vector, Hₖ is a transition matrix for the observation equation, Rₖ is a covariance matrix corresponding to the observation vector;

$$Q = \frac{{q}_{0} + {q}_{1} i + {q}_{2} j + {q}_{3} k}{\sqrt{{q}_{0}^{2} + {q}_{1}^{2} + {q}_{2}^{2} + {q}_{3}^{2}}}$$

wherein Q is a quaternion vector, q₀, q₁, q₂, q₃ are scalars forming the quaternion vector, i, j, k are unit vectors in a three-dimensional coordinate system, an updated attitude matrix is as below:

$${C}_{b}^{n} = [ \begin{matrix}{q}_{1}^{2} + {q}_{0}^{2} - {q}_{3}^{2} - {q}_{2}^{2} & 2 ( {q}_{1} {q}_{2} - {q}_{0} {q}_{3} ) & 2 ( {q}_{1} {q}_{3} + {q}_{0} {q}_{2} ) \\ 2 ( {q}_{1} {q}_{2} + {q}_{0} {q}_{3} ) & {q}_{2}^{2} - {q}_{3}^{2} + {q}_{0}^{2} - {q}_{1}^{2} & 2 ( {q}_{2} {q}_{3} - {q}_{0} {q}_{1} ) \\ 2 ( {q}_{1} {q}_{3} + {q}_{0} {q}_{2} ) & 2 ( {q}_{2} {q}_{3} + {q}_{0} {q}_{1} ) & {q}_{3}^{2} - {q}_{2}^{2} - {q}_{1}^{2} + {q}_{0}^{2}\end{matrix} ]$$

wherein C_{b}ⁿ is a rotation matrix for transforming a carrier coordinate system to a navigation coordinate system,

$${C}_{b}^{n} = ( \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ) = ( \begin{matrix}\begin{matrix}cos γcosψ + \\ sin γ sin ψsin θ\end{matrix} & sin ψcosθ & \begin{matrix}sin γ cos ψ - \\ cos γsinψsinθ\end{matrix} \\ \begin{matrix}- cos γsin ψ + \\ sin γcosψsinθ\end{matrix} & cos ψcosθ & \begin{matrix}- sin γ sin ψ - \\ cos γcosψsinθ\end{matrix} \\ - sin γcosθ & sin θ & cos γcos θ\end{matrix} )$$

wherein γ, θ, ψ are a rolling angle, a pitch angle, and the course angle respectively.

According to one aspect of the present invention, after the step of data-fusion processing the angle, the velocity, the position information and the course angle of the vehicle by the seven-dimensional EKF filtering model, and updating a motional attitude angle of the vehicle in real time, the following step is performed:

extracting the all-attitude angle data of the vehicle from updated attitude data of the vehicle, to determine a value of attitude angle data, the all-attitude angle of the vehicle including the pitch angle, the rolling angle and the course angle, wherein,

$$\{ \begin{matrix}{ψ}_{Principal} = arctan ( - \frac{{C}_{12}}{{C}_{22}} ) \\ {θ}_{Principal} = arcsin {C}_{32} \\ {γ}_{Principal} = arctan ( - \frac{{C}_{31}}{{C}_{33}} )\end{matrix}$$

the course angle is:

$$ψ = \{ \begin{matrix}{ψ}_{principle} & \\ {ψ}_{principle} + 360 ° & When {C}_{22} > 0 \{ \begin{matrix}{ψ}_{principle} > 0 \\ {ψ}_{principle} < 0\end{matrix} \\ {ψ}_{principle} - 180 ° & When {C}_{22} < 0\end{matrix}$$

the pitch angle is:
   θ=θ_{principle}
the rolling angle is:

$$γ = \{ \begin{matrix}{γ}_{principle} + 180 ° & \\ {γ}_{principle} - 180 ° & When {C}_{33} > 0 \{ \begin{matrix}{γ}_{principle} > 0 \\ {ψ}_{principle} < 0\end{matrix} \\ {γ}_{principle} & When {C}_{33} < 0\end{matrix} .$$

The beneficial effects of the invention are provided as below: the acceleration and the angular velocity of the object in motion are acquired in real time by a MEMS sensor. The angular acceleration output by the gyroscope is integrated to obtain the angle. The acceleration is integrated to calculate the velocity, which is further integrated to calculate the position information. The geomagnetic field is obtained by the geomagnetic sensor, and the course angle is calculated by the compensation algorithm and the fusion of gyroscope. Next, the attitudes are converted into a transition matrix, so that the carrier coordinate system is transformed into a navigation coordinate system. This transition matrix functions as a “mathematical platform”. The SINS (Strapdown inertial navigation system) algorithm is applied to the agricultural machine, and the transition matrix is particularly important. Since the agricultural machine keeps moving, the attitudes thereof are also continuously changing. Thus, the transition matrix also needs to be continuously recalculated and updated. The conventional attitude updating algorithms include Euler angle algorithm, direction cosine algorithm, and quaternion algorithm. Compared with the Euler angle algorithm, the quaternion algorithm has no singular point. Compared with the direction cosine algorithm, the quaternion algorithm has a small calculation amount. Hence, the quaternion algorithm is very suitable for being used in the embedded product. The earth's magnetic field and the error model of the gyroscope are established in the agricultural machine plane, and a seven-dimensional EKF (Extended Kalman Filter) is established to update the attitude matrix. The quaternion and the zero offset of the gyroscope are estimated and then an observation is performed from the course angle calculated through the acceleration and the magnetic field intensity, so that a high-precision three-dimensional attitude angle can be obtained. The error compensation algorithm and the correction algorithm greatly reduce the error interference of the SINS algorithm. The MEMS sensor and the SINS algorithm ensure that the present invention has high-performance parameters. As tested by a tractor, the error of the output course angle is less than 0.1°, and the pitch angle error and the rolling angle error are less than 0.01°. Since the quaternion is used as a Kalman filtering state vector, the calculation accuracy of the target parameters can be further improved.

### BRIEF DESCRIPTION OF THE DRAWINGS

To illustrate the technical solutions of the embodiments of the invention more clearly, the accompanying drawings required for the embodiments are briefly introduced here. Apparently, the accompanying drawings in the following description are only some embodiments of the present invention. For a person of ordinary skill in the art, other accompanying drawings can be derived from these accompanying drawings, without making any creative efforts.

FIG. 1 is a flow chart of a method of updating the all-attitude angle of an agricultural machine based on a nine-axis MEMS sensor according to Embodiment 1 of the invention;

FIG. 2 is a flow chart of a method of updating the all-attitude angle of an agricultural machine based on a nine-axis MEMS sensor according to Embodiment 2 of the invention.

### DETAILED DESCRIPTION OF THE INVENTION

The present invention will hereinafter be clearly and fully described, with reference to the accompanying drawings in the embodiments of the present invention. Apparently, the embodiments to be described are only certain embodiments of the present invention, rather than all the embodiments. Based on the embodiments of the present invention, the other embodiments made by a person of ordinary skill in the art without any creative efforts, all fall into the protection scope of the present invention.

### Embodiment 1

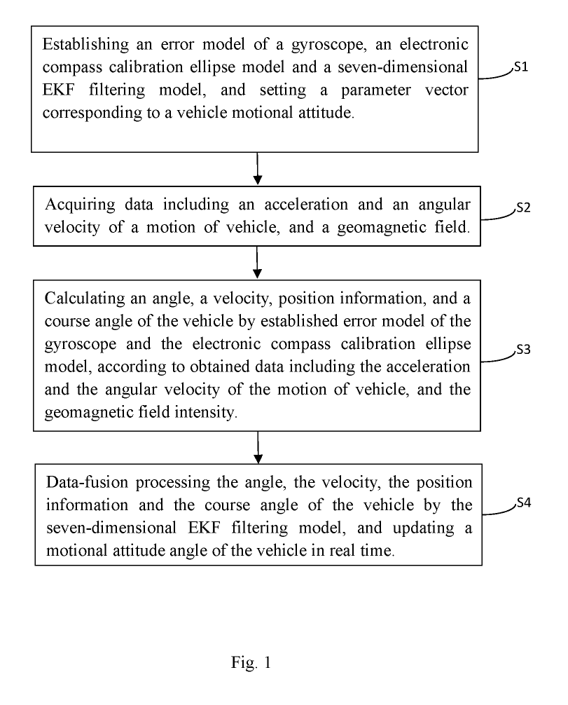

As shown in FIG. 1, a method of updating the all-attitude angle of an agricultural machine based on a nine-axis MEMS sensor includes the following steps:

Step S1: an error model of the gyroscope, an electronic compass calibration ellipse model and a seven-dimensional EKF filtering model are established, and parameter vectors corresponding to vehicle motional attitudes are set.

The step S1 of establishing an error model of the gyroscope, an electronic compass calibration ellipse model and a seven-dimensional EKF filtering model, and setting parameter vectors corresponding to vehicle motional attitudes is described in detail as below:

The angular velocity of the gyroscope is calculated in the error model of the gyroscope via an error calculation formula of the gyroscope, wherein the error calculation formula of the gyroscope is: ω=ω_{ib}+b_{ωr}+b_{ωg}, wherein ω is an angular velocity output by the gyroscope, ω_{ib} is a real angular velocity of the gyroscope, b_{ωr} is a zero drift of the gyroscope, and b_{ωg} is a white noise output by the gyroscope.

The magnetic field interference is eliminated by the electronic compass calibration ellipse model, wherein the electronic compass calibration ellipse model is:

$$\frac{{( mx - Xoffset )}^{2}}{{Xsf}^{ 2}} + \frac{{( my - Yoffset )}^{2}}{{Ysf}^{ 2}} = 1 ,$$

wherein mx, my are magnetic field intensities, Xoffset and Yoffset are hard magnetic interferences, and Xsf and Ysf are soft magnetic interferences.

The vehicle attitudes are updated by the seven-dimensional EKF filtering model, wherein the seven-dimensional EKF filtering model uses an extended Kalman filter for a seven-dimensional state vector, and EKF includes a state equation and an observation equation:

\dot{x}=f(x,ω)+w1

y=h(x)+v1

The state matrix is: x=[q b_{ωr}], wherein q is quaternion vectors q0, q1, q2, q3, b_{ωr} is a zero drift of the XYZ three-axis gyroscope; wherein ω is an angular velocity output by the gyroscope, w1 is a process noise matrix, v1 is an observation noise matrix, y is an observation vector, y=[a ψ_{mag}]^{T}, wherein a is a three-axis acceleration value, ψ_{mag} is a course angle calculated by the electronic compass,

$$f ( x , ω ) = [ \frac{1}{2} [ {\begin{matrix}- {q}_{1} & - {q}_{2} & - {q}_{3} \\ {q}_{0} & - {q}_{3} & {q}_{2} \\ {q}_{3} & {q}_{0} & - {q}_{1} \\ - {q}_{2} & {q}_{1} & {q}_{0}\end{matrix}}_{{0}^{3 \times 1}} ] [ \begin{matrix}{ω}_{x} - {b}_{ω x} \\ {ω}_{y} - {b}_{ω y} \\ {ω}_{z} - {b}_{ω z}\end{matrix} ] ]$$

$$h = [ \begin{matrix}2 g ( {q}_{1} {q}_{3} - {q}_{0} {q}_{2} ) \\ 2 g ( {q}_{2} {q}_{3} + {q}_{0} {q}_{1} ) \\ g ( {q}_{0}^{2} - {q}_{1}^{2} - {q}_{2}^{2} + {q}_{3}^{2} ) \\ {tan}^{- 1} ( \frac{2 ( {q}_{1} {q}_{2} + {q}_{0} {q}_{3} )}{{q}_{0}^{2} + {q}_{1}^{2} - {q}_{2}^{2} - {q}_{3}^{2}} )\end{matrix} ] .$$

Since the geomagnetic field has a weak intensity, it is susceptible to the influence of surrounding ferrous material and electromagnetic field. Therefore, it is necessary to calibrate the gyroscope first. The electronic compass calibration ellipse model is established to eliminate the interference from the magnetic field. The acquired magnetic field intensity is fitted by the least square method in the actual calibration process, such that the above parameters are obtained.

Step S2: The data including the acceleration and the angular velocity of the motion of vehicle, and the geomagnetic field intensity are acquired in real time by a nine-axis MEMS sensor.

The step S2 of acquiring the data including the acceleration and the angular velocity of the motion of vehicle, and the geomagnetic field intensity in real time by a nine-axis MEMS sensor is described in detail as below:

The angular velocity of the vehicle is obtained through a gyroscope, and the zero drift of the gyroscope is compensated.

An acceleration sensor is used to acquire the acceleration data of the vehicle.

The geomagnetic field intensity of the vehicle is acquired by a geomagnetic sensor.

Step S3: According to the obtained data including the acceleration and the angular velocity of the motion of vehicle, and the geomagnetic field intensity, the angle, the velocity, the position information, and the course angle of the vehicle are calculated by the established error model of the gyroscope and the electronic compass calibration ellipse model.

The step S3 of calculating the angle, the velocity, the position information, and the course angle of the vehicle by the established error model of the gyroscope and the electronic compass calibration ellipse model, according to the obtained data including the acceleration and the angular velocity of the motion of vehicle, and the geomagnetic field intensity, is described in detail as below.

The angle data is obtained by an integral calculation of the angular velocity by the error model of the gyroscope.

The velocity is calculated by integrating the acceleration data, and the position information is calculated by further integrating the velocity.

The course angle of the vehicle is then calculated from the geomagnetic field intensity data which is compensated by calibration parameter and corrected by the oblique angle, and both the calibration parameter and the oblique angle are calculated by the elliptical model.

The motion information of the vehicle is acquired by the MEMS sensor in real time. The angular velocity of the vehicle acquired by the gyroscope is corrected by the state estimation and the zero offset of the gyroscope. The angular velocity of the vehicle is integrated to calculate the angle increment. The geomagnetic sensor is corrected and compensated by the soft magnetism, the hard magnetism, and the oblique angle to calculate the course angle.

Step S4: The angle, the velocity, the position information and the course angle of the vehicle are data-fusion processed by the seven-dimensional EKF filtering model, and the motional attitude angle of the vehicle is updated in real time.

The step S4 of data-fusion processing the angle, the velocity, the position information and the course angle of the vehicle by the seven-dimensional EKF filtering model, and updating the motional attitude angle of the vehicle in real time, is described in detail as below.

The attitude data of the vehicle is calculated by the seven-dimensional EKF filtering model, through the quaternion attitude updating algorithm, wherein the calculation process of the EKF algorithm is as below:

$${\hat{x}}_{k} ( - ) = {Φ}_{k - 1} {\hat{x}}_{k} ( + )$$

$${Φ}_{k} = {e}^{\frac{\partial f}{\partial x}}$$

$${P}_{k} ( - ) = {Φ}_{k - 1} {P}_{k - 1} ( + ) {Φ}_{k - 1}^{T} + Q$$

$${\hat{x}}_{k} ( + ) = {\hat{x}}_{k} ( - ) + {K}_{k} \vert {y}_{k} - h ( {\hat{x}}_{k} ( - ) ) \vert$$

$${P}_{k} ( + ) = [ I - {K}_{k} {H}_{k} ] {P}_{k} ( - ) \\ {H}_{k} = \frac{\partial h}{\partial x} {\vert}_{k} \\ {K}_{k} = {P}_{k} ( - ) {H}_{k} [ {H}_{k} {P}_{k} ( - ) {H}_{k}^{T} + {R}_{k} ]$$

In the above formula, k is a sampling time point, \hat{x}ₖ is a system state estimation, (−) is the previous time point, (+) is the later time point, Φₖ is a state transition matrix, Pₖ is a minimum mean square error matrix, Q is a covariance matrix corresponding to the state vector, Kₖ is an error gain, yₖ is an observation vector, Hₖ is a transition matrix for the observation equation, Rₖ is a covariance matrix corresponding to the observation vector.

$$Q = \frac{{q}_{0} + {q}_{1} i + {q}_{2} j + {q}_{3} k}{\sqrt{{q}_{0}^{2} + {q}_{1}^{2} + {q}_{2}^{2} + {q}_{3}^{2}}}$$

In the above formula, Q is a quaternion vector, q0, q1, q2, q3 are scalars forming a quaternion vector, i, j, k are unit vectors in the three-dimensional coordinate system. The updated attitude matrix is as below:

$${C}_{b}^{n} = [ \begin{matrix}{q}_{1}^{2} + {q}_{0}^{2} - {q}_{3}^{2} - {q}_{2}^{2} & 2 ( {q}_{1} {q}_{2} - {q}_{0} {q}_{3} ) & 2 ( {q}_{1} {q}_{3} + {q}_{0} {q}_{2} ) \\ 2 ( {q}_{1} {q}_{2} + {q}_{0} {q}_{3} ) & {q}_{2}^{2} - {q}_{3}^{2} + {q}_{0}^{2} - {q}_{1}^{2} & 2 ( {q}_{2} {q}_{3} - {q}_{0} {q}_{1} ) \\ 2 ( {q}_{1} {q}_{3} + {q}_{0} {q}_{2} ) & 2 ( {q}_{2} {q}_{3} + {q}_{0} {q}_{1} ) & {q}_{3}^{2} - {q}_{2}^{2} - {q}_{1}^{2} + {q}_{0}^{2}\end{matrix} ]$$

In the above formula, C_{b}ⁿ is a rotation matrix for transforming a carrier coordinate system to a navigation coordinate system.

$${C}_{b}^{n} = ( \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ) = ( \begin{matrix}\begin{matrix}cos γcosψ + \\ sin γ sin ψsin θ\end{matrix} & sin ψcosθ & \begin{matrix}sin γ cos ψ - \\ cos γsinψsinθ\end{matrix} \\ \begin{matrix}- cos γsin ψ + \\ sin γcosψsinθ\end{matrix} & cos ψcosθ & \begin{matrix}- sin γ sin ψ - \\ cos γcosψsinθ\end{matrix} \\ - sin γcosθ & sin θ & cos γcos θ\end{matrix} )$$

In the above formula, γ, θ, ψ are a rolling angle, a pitch angle and a course angle respectively.

In the above formula, the nine-axis MEMS sensor is composed of a three-axis gyroscope, a three-axis accelerometer, and a three-axis geomagnetic sensor.

### Embodiment 2

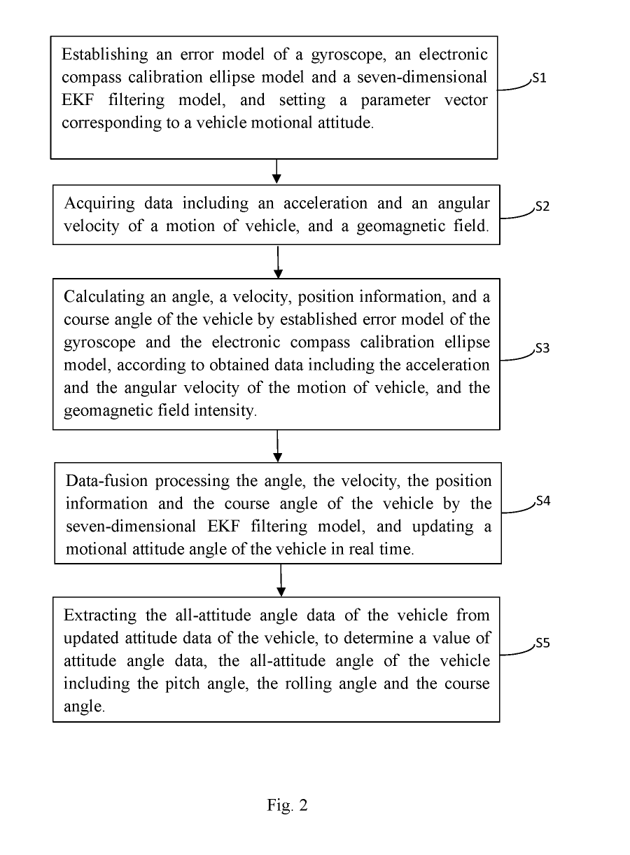

As shown in FIG. 2, a method of updating the all-attitude angle of an agricultural machine based on a nine-axis MEMS sensor is provided. The method includes the following steps:

Step S1: an error model of the gyroscope, an electronic compass calibration ellipse model and a seven-dimensional EKF filtering model are established, and parameter vectors corresponding to vehicle motional attitudes are set.

The step S1 of establishing an error model of the gyroscope, an electronic compass calibration ellipse model and a seven-dimensional EKF filtering model, and setting parameter vectors corresponding to vehicle motional attitudes is described in detail as below:

The angular velocity of the gyroscope is calculated in the error formula of the gyroscope via an error calculation formula of the gyroscope, wherein the error calculation formula of the gyroscope is: ω=ω_{ib}+b_{ωr}+b_{ωg}, wherein w is an angular velocity output by the gyroscope, ω_{ib} is a real angular velocity of the gyroscope, b_{ωr} is a zero drift of the gyroscope, and b_{ωg} is a white noise output by the gyroscope.

The magnetic field interference is eliminated by the electronic compass calibration ellipse model, wherein the electronic compass calibration ellipse model is:

$$\frac{{( mx - Xoffset )}^{2}}{{Xsf}^{ 2}} + \frac{{( my - Yoffset )}^{2}}{{Ysf}^{ 2}} = 1 ,$$

wherein mx, my are magnetic field intensities, Xoffset and Yoffset are hard magnetic interferences, and Xsf and Ysf are soft magnetic interferences.

The vehicle attitudes are updated by the seven-dimensional EKF filtering model, wherein the seven-dimensional EKF filtering model is an extended Kalman filter of a seven-dimensional state vector, and EKF includes a state equation and an observation equation:

\dot{x}=(x,ω)+w1

y=h(x)+v1

The state matrix is: x=[q b_{ωr}], wherein q is quaternion vectors q0, q1, q2, q3, b_{ωr} is a zero drift of the XYZ three-axis gyroscope. In the formula, ω is an angular velocity output by the gyroscope, w1 is a process noise matrix, v1 is an observation noise matrix, y is an observation vector, y=[a ψ_{mag}]^{T}, wherein a is a three-axis acceleration value, ψ_{mag} is a course angle calculated by the electronic compass,

$$f ( x , ω ) = [ \frac{1}{2} [ {\begin{matrix}- {q}_{1} & - {q}_{2} & - {q}_{3} \\ {q}_{0} & - {q}_{3} & {q}_{2} \\ {q}_{3} & {q}_{0} & - {q}_{1} \\ - {q}_{2} & {q}_{1} & {q}_{0}\end{matrix}}_{{0}^{3 \times 1}} ] [ \begin{matrix}{ω}_{x} - {b}_{ω x} \\ {ω}_{y} - {b}_{ω y} \\ {ω}_{z} - {b}_{ω z}\end{matrix} ] ]$$

$$h = [ \begin{matrix}2 g ( {q}_{1} {q}_{3} - {q}_{0} {q}_{2} ) \\ 2 g ( {q}_{2} {q}_{3} + {q}_{0} {q}_{1} ) \\ g ( {q}_{0}^{2} - {q}_{1}^{2} - {q}_{2}^{2} + {q}_{3}^{2} ) \\ {tan}^{- 1} ( \frac{2 ( {q}_{1} {q}_{2} + {q}_{0} {q}_{3} )}{{q}_{0}^{2} + {q}_{1}^{2} - {q}_{2}^{2} - {q}_{3}^{2}} )\end{matrix} ] .$$

Since the geomagnetic field has a weak intensity, it is susceptible to the influence of surrounding ferrous material and electromagnetic fields. Therefore, it is necessary to calibrate the gyroscope first. The electronic compass calibration ellipse model is established to eliminate the interference from the magnetic field. The acquired magnetic field intensity is fitted by the least square method in the actual calibration process, such that the above parameters are obtained.

Step S2: The data including the acceleration, and the angular velocity of the motion of vehicle, and the geomagnetic field intensity are acquired in real time by a nine-axis MEMS sensor.

The step S2 of acquiring the data including the acceleration and the angular velocity of the motion of vehicle, and the geomagnetic field intensity in real time by a nine-axis MEMS sensor is described in detail as below:

The angular velocity of the vehicle is obtained through a gyroscope, and the zero drift of the gyroscope is compensated.

An acceleration sensor is used to acquire the acceleration data of the vehicle.

The geomagnetic field intensity of the vehicle is acquired by a geomagnetic sensor.

Step S3: According to the obtained data including the acceleration and the angular velocity of the motion of vehicle, and the geomagnetic field intensity, the angle, the velocity, the position information, and the course angle of the vehicle are calculated by the established error model of the gyroscope and the electronic compass calibration ellipse model.

The step S3 of calculating the angle, the velocity, the position information, and the course angle of the vehicle by the established error model of the gyroscope and the electronic compass calibration ellipse model, according to the obtained data including the acceleration and the angular velocity of the motion of vehicle, and the geomagnetic field intensity, is described in detail as below.

The angle data is obtained by an integral calculation of the angular velocity by the error model of the gyroscope.

The velocity is calculated by integrating the acceleration data, and the position information is calculated by further integrating the velocity.

The course angle of the vehicle is then calculated from the geomagnetic field intensity data which is compensated by calibration parameter and corrected by the oblique angle, and both the calibration parameter and the oblique angle are calculated by the elliptical model.

The motion information of the vehicle is acquired by the MEMS sensor in real time. The angular velocity of the vehicle acquired by the gyroscope is corrected by the state estimation and the zero offset of the gyroscope. The angular velocity of the vehicle is integrated to calculate the angle increment. The geomagnetic sensor is corrected and compensated by the soft magnetism, the hard magnetism, and the oblique angle to calculate the course angle.

Step S4: The angle, the velocity, the position information and the course angle of the vehicle are data-fusion processed by the seven-dimensional EKF filtering model, and the motional attitude angle of the vehicle is updated in real time.

The step S4 of data-fusion processing the angle, the velocity, the position information and the course angle of the vehicle by the seven-dimensional EKF filtering model, and updating the motional attitude angle of the vehicle in real time, is described in detail as below.

The attitude data of the vehicle is calculated by the seven-dimensional EKF filtering model, through the quaternion attitude updating algorithm, wherein the calculation process of the EKF algorithm is as below:

$${\hat{x}}_{k} ( - ) = {Φ}_{k - 1} {\hat{x}}_{k} ( + )$$

$${Φ}_{k} = {e}^{\frac{\partial f}{\partial x}}$$

$${P}_{k} ( - ) = {Φ}_{k - 1} {P}_{k - 1} ( + ) {Φ}_{k - 1}^{T} + Q$$

$${\hat{x}}_{k} ( + ) = {\hat{x}}_{k} ( - ) + {K}_{k} \vert {y}_{k} - h ( {\hat{x}}_{k} ( - ) ) \vert$$

$${P}_{k} ( + ) = [ I - {K}_{k} {H}_{k} ] {P}_{k} ( - )$$

$${H}_{k} = \frac{\partial h}{\partial x} {\vert}_{k} \\ {K}_{k} = {P}_{k} ( - ) {H}_{k} [ {H}_{k} {P}_{k} ( - ) {H}_{k}^{T} + {R}_{k} ]$$

In the above formula, k is a sampling time point, \hat{x}ₖ is a system state estimation, (−) is the previous time point, (+) is the later time point, Φₖ is a state transition matrix, Pk is a minimum mean square error matrix, Q is a covariance matrix corresponding to the state vector, Kk is an error gain, yk is an observation vector, Hk is a transition matrix for the observation equation, Rk is a covariance matrix corresponding to the observation vector.

$$Q = \frac{{q}_{0} + {q}_{1} i + {q}_{2} j + {q}_{3} k}{\sqrt{{q}_{0}^{2} + {q}_{1}^{2} + {q}_{2}^{2} + {q}_{3}^{2}}}$$

In the above formula, Q is a quaternion vector, q0, q1, q2, q3 are scalars forming a quaternion vector, i, j, k are unit vectors in the three-dimensional coordinate system, the updated attitude matrix is as below:

$${C}_{b}^{n} = [ \begin{matrix}{q}_{1}^{2} + {q}_{0}^{2} - {q}_{3}^{2} - {q}_{2}^{2} & 2 ( {q}_{1} {q}_{2} - {q}_{0} {q}_{3} ) & 2 ( {q}_{1} {q}_{3} + {q}_{0} {q}_{2} ) \\ 2 ( {q}_{1} {q}_{2} + {q}_{0} {q}_{3} ) & {q}_{2}^{2} - {q}_{3}^{2} + {q}_{0}^{2} - {q}_{1}^{2} & 2 ( {q}_{2} {q}_{3} - {q}_{0} {q}_{1} ) \\ 2 ( {q}_{1} {q}_{3} + {q}_{0} {q}_{2} ) & 2 ( {q}_{2} {q}_{3} + {q}_{0} {q}_{1} ) & {q}_{3}^{2} - {q}_{2}^{2} - {q}_{1}^{2} + {q}_{0}^{2}\end{matrix} ]$$

In the above formula, C_{b}ⁿ is a rotation matrix for transforming a carrier coordinate system to a navigation coordinate system.

$${C}_{b}^{n} = ( \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ) = ( \begin{matrix}cos γ cos ψ + sin γ sin ψ sin θ & sin ψ cos θ & sin γ cos ψ - cos γ sin ψ sin θ \\ - cos γ sin ψ + sin γ cos ψ sin θ & cos ψ cos θ & - sin γ sin ψ - cos γ cos ψ sin θ \\ - sin γ cos θ & sin θ & cos γ cos θ\end{matrix} )$$

In the above formula, γ, θ, ψ are a rolling angle, a pitch angle, and a course angle respectively.

In the above formula, the nine-axis MEMS sensor is composed of a three-axis gyroscope, a three-axis accelerometer, and a three-axis geomagnetic sensor.

Step S5: The all-attitude angle data of the vehicle is extracted from the updated attitude data of the vehicle, to determine the value of the attitude angle data. The all-attitude angle of the vehicle includes a pitch angle, a rolling angle and a course angle, wherein,

$$\{ \begin{matrix}{ψ}_{Principal} = arctan ( - \frac{{C}_{12}}{{C}_{22}} ) \\ {θ}_{Principal} = arcsin {C}_{32} \\ {γ}_{Principal} = arctan ( - \frac{{C}_{31}}{{C}_{33}} )\end{matrix}$$

The course angle is:

$$ψ = \{ \begin{matrix}{ψ}_{principle} & \\ {ψ}_{principle} + 360 ° & When {C}_{22} > 0 \{ \begin{matrix}{ψ}_{principle} > 0 \\ {ψ}_{principle} < 0\end{matrix} \\ {ψ}_{principle} + 180 ° & When {C}_{22} < 0\end{matrix}$$

The pitch angle is:
   θ=θ_{principle}
The rolling angle is:

$$γ = \{ \begin{matrix}{γ}_{principle} + 180 ° & \\ {γ}_{principle} - 180 ° & When {C}_{33} > 0 \{ \begin{matrix}{γ}_{principle} > 0 \\ {γ}_{principle} < 0\end{matrix} \\ {γ}_{principle} & When {C}_{33} < 0\end{matrix}$$

The all-attitude attitude angle of the vehicle can be extracted from the updated and calculated attitude matrix C_{b}ⁿ, and the all-attitude attitude angle includes the pitch angle, the rolling angle and the course angle. Since the pitch angle θ is defined within the interval of [−90°, +90° ], which is consistent with the principal value of an inverse sine function, there is no problem of multi-value. The rolling angle γ is defined within the interval of [180°, 180° ]. The course angle ψ is defined within the interval of [0°, 360°]. Hence, there are problems of multi-value for both γ and ψ. After the principle value is calculated, the specific quadrant can be determined by the elements in C_{b}ⁿ.

The advantages of the invention are as below: the acceleration and the angular velocity of the motion of the object are acquired in real time by a MEMS sensor. The angular acceleration output by the gyroscope is integrated to obtain the angle. The acceleration is integrated to calculate the velocity, which is further integrated to calculate the position information. The geomagnetic field is obtained by the geomagnetic sensor, and the course angle is calculated by the compensation algorithm and the fusion of gyroscope. Next, the attitudes are converted into a transition matrix, so that the carrier coordinate system is transformed into a navigation coordinate system. This transition matrix functions as a “mathematical platform”. The SINS (Strapdown inertial navigation system) algorithm is applied to the agricultural machine, and the transition matrix is particularly important. Since the agricultural machine keeps moving, the attitudes thereof are also continuously changing. Thus, the transition matrix also needs to be continuously recalculated and updated. The conventional attitude updating algorithms include Euler angle algorithm, direction cosine algorithm, and quaternion algorithm. Compared with the Euler angle algorithm, the quaternion algorithm has no singular point. Compared with the direction cosine algorithm, the quaternion algorithm has a small calculation amount. Hence, the quaternion algorithm is very suitable for being used in the embedded product. The geomagnetic field and the error model of the gyroscope are established in the agricultural machine plane, and a seven-dimensional EKF (Extended Kalman Filter) is established to update the attitude matrix. The quaternion and the zero offset of the gyroscope are estimated. Next, an observation is performed from the course angle calculated through the acceleration and the magnetic field intensity, so that a high-precision three-dimensional attitude angle can be obtained. The error compensation algorithm and the correction algorithm greatly reduce the error interference of the SINS algorithm. The MEMS sensor and the SINS algorithm ensure that the present invention has high-performance parameters. As tested by a tractor, the error of the output course angle is less than 0.1°, and the pitch angle error and the rolling angle error are less than 0.01°. Since the quaternion is used as a Kalman filtering state vector, the calculation accuracy of the target parameters can be further improved.

The above description is merely illustrative of specific embodiments of the present invention, but the protection scope of the present invention is not limited thereto. The modifications or replacements easily conceived by a person of ordinary skill in the art, within the scope of the disclosure in the present invention, shall all fall into the protection scope of the present invention. Therefore, the protection scope of the present invention should be decided by the appended claims.

1. A method of updating an all-attitude angle of an agricultural machine based on a nine-axis MEMS sensor, comprising the following steps:
establishing an error model of a gyroscope, an electronic compass calibration ellipse model and a seven-dimensional EKF filtering model, and setting a parameter vector corresponding to a vehicle motional attitude;
acquiring data including an acceleration and an angular velocity of a motion of vehicle, and a geomagnetic field intensity in real time by a nine-axis MEMS sensor;
calculating an angle, a velocity, position information, and a course angle of the vehicle by established error model of the gyroscope and the electronic compass calibration ellipse model, according to obtained data including the acceleration and the angular velocity of the motion of vehicle, and the geomagnetic field intensity; and
data-fusion processing the angle, the velocity, the position information and the course angle of the vehicle by the seven-dimensional EKF filtering model, and updating a motional attitude angle of the vehicle in real time;
wherein the nine-axis MEMS sensor is composed of a three-axis gyroscope, a three-axis acceleration sensor, and a three-axis geomagnetic sensor.

2. The method of updating an all-attitude angle of an agricultural machine based on a nine-axis MEMS sensor of claim 1, wherein the step of establishing an error model of a gyroscope, an electronic compass calibration ellipse model and a seven-dimensional EKF filtering model, and setting a parameter vector corresponding to a vehicle motional attitude further includes,
calculating the angular velocity of the gyroscope in the error model of the gyroscope via an error calculation formula of the gyroscope; wherein the error calculation formula of the gyroscope is: ω=ω_{ib}+b_{ωr}+b_{ωg}, wherein co is an angular velocity output by the gyroscope, ω_{ib} is a real angular velocity of the gyroscope, b_{ωr} is a zero drift of the gyroscope, and b_{ωg} is a white noise output by the gyroscope;
eliminating a magnetic field interference by the electronic compass calibration ellipse model; wherein the electronic compass calibration ellipse model is:
$$\frac{{( mx - Xoffset )}^{2}}{{Xsf}^{ 2}} + \frac{{( my - Yoffset )}^{2}}{{Ysf}^{ 2}} = 1 ,$$
wherein mx, my are magnetic field intensities, Xoffset and Yoffset are hard magnetic interferences, and Xsf and Ysf are soft magnetic interferences;
updating the vehicle attitude by the seven-dimensional EKF filtering model, wherein, the seven-dimensional EKF filtering model uses an extended Kalman filter for a seven-dimensional state vector, and EKF includes a state equation and an observation equation:
\dot{x}=f(x,ω)+w1
y=h(x)+v1
wherein the state matrix is x [q, b_{ωr}], is quaternion vectors q₀, q₁, q₂, q₃, and b_{ωr} is a zero drift of the three-axis gyroscope, wherein ω is the angular velocity output by the gyroscope, w1 is a process noise matrix, v1 is an observation noise matrix, y is an observation vector, y=[a ψ_{mag}]^{T}, wherein a is a three-axis acceleration value, ψ_{nag} is a course angle calculated by the electronic compass,
$$f ( x , ω ) = [ {\frac{1}{2} [ \begin{matrix}- {q}_{1} & - {q}_{2} & - {q}_{3} \\ {q}_{0} & - {q}_{3} & {q}_{2} \\ {q}_{3} & {q}_{0} & - {q}_{1} \\ - {q}_{2} & {q}_{1} & {q}_{0}\end{matrix} ]}_{ {0}^{3 \times 1}} [ \begin{matrix}{ω}_{x} - {b}_{ω rx} \\ {ω}_{y} - {b}_{ω ry} \\ {ω}_{2} - {b}_{ω rz}\end{matrix} ] ]$$
$$h = [ \begin{matrix}2 g ( {q}_{1} {q}_{3} - {q}_{0} {q}_{2} ) \\ 2 g ( {q}_{2} {q}_{3} + {q}_{0} {q}_{1} ) \\ g ( {q}_{0}^{2} - {q}_{1}^{2} - {q}_{2}^{2} + {q}_{3}^{2} ) \\ {tan}^{- 1} ( \frac{2 ( {q}_{1} {q}_{2} + {q}_{0} {q}_{3} )}{{q}_{0}^{2} + {q}_{1}^{2} - {q}_{2}^{2} - {q}_{3}^{2}} )\end{matrix} ] .$$

3. The method of updating an all-attitude angle of an agricultural machine based on a nine-axis MEMS sensor of claim 2, wherein the step of acquiring data including an acceleration and an angular velocity of a motion of vehicle, and an geomagnetic field intensity in real time by a nine-axis MEMS sensor further includes,
obtaining the angular velocity of the vehicle through the gyroscope, and compensating the zero drift of the gyroscope;
acquiring the acceleration of the vehicle by the acceleration sensor; and
acquiring the geomagnetic field intensity of the vehicle by the geomagnetic sensor.

4. The method of updating an all-attitude angle of an agricultural machine based on a nine-axis MEMS sensor of claim 3, wherein the step of calculating an angle, a velocity, position information, and a course angle of the vehicle by established error model of the gyroscope and the electronic compass calibration ellipse model, according to obtained data including the acceleration and the angular velocity of the motion of vehicle, and the geomagnetic field intensity further includes,
obtaining the angle by an integral calculation of the angular velocity by the error model of the gyroscope;
calculating the velocity by integrating the acceleration, and the position information is calculated by further integrating the velocity; and
calculating the course angle of the vehicle from the geomagnetic field intensity which is compensated by a calibration parameter and corrected by an oblique angle, and both the calibration parameter and the oblique angle being calculated by the elliptical model.

5. The method of updating an all-attitude angle of an agricultural machine based on a nine-axis MEMS sensor of claim 4, wherein the step of data-fusion processing the angle, the velocity, the position information and the course angle of the vehicle by the seven-dimensional EKF filtering model, and updating the motional attitude angle of the vehicle in real time further includes,
calculating the motional attitude angle of the vehicle by the seven-dimensional EKF filtering model, through a quaternion attitude updating algorithm, wherein a calculation process of the EKF algorithm is as below:
$${\hat{x}}_{k} ( - ) = {Φ}_{k - 1} {\hat{x}}_{k} ( + )$$
$${Φ}_{k} = {e}^{\frac{\partial f}{\partial x}}$$
$${P}_{k} ( - ) = {Φ}_{k - 1} {P}_{k - 1} ( + ) {Φ}_{k - 1}^{T} + Q$$
$${\hat{x}}_{k} ( + ) = {\hat{x}}_{k} ( - ) + {K}_{k} \vert {y}_{k} - h ( {\hat{x}}_{k} ( - ) ) \vert$$
$${P}_{k} ( + ) = [ I - {K}_{k} {H}_{k} ] {P}_{k} ( - )$$
$${H}_{k} = \frac{\partial h}{\partial x} {\vert}_{k} \\ {K}_{k} = {P}_{k} ( - ) {H}_{k} [ {H}_{k} {P}_{k} ( - ) {H}_{k}^{T} + {R}_{k} ]$$
wherein k is a sampling time point, \vec{x}ₖ is a system state estimation, (−) is a previous time point, (+) is a later time point, Φₖ is a state transition matrix, Pₖ is a minimum mean square error matrix, Q is a covariance matrix corresponding to the state vector, Kₖ is an error gain, yₖ is an observation vector, Hₖ is a transition matrix for the observation equation, Rₖ is a covariance matrix corresponding to the observation vector;
$$Q = \frac{{q}_{0} + {q}_{1} i + {q}_{2} j + {q}_{3} k}{\sqrt{{q}_{0}^{2} + {q}_{1}^{2} + {q}_{2}^{2} + {q}_{3}^{2}}}$$
wherein Q is a quaternion vector, q₀, q₁, q₂, q₃ are scalars forming the quaternion vector, i, j, k are unit vectors in a three-dimensional coordinate system, an updated attitude matrix is as below:
$${C}_{b}^{n} = [ \begin{matrix}{q}_{1}^{2} + {q}_{0}^{2} - {q}_{3}^{2} - {q}_{2}^{2} & 2 ( {q}_{1} {q}_{2} - {q}_{0} {q}_{3} ) & 2 ( {q}_{1} {q}_{3} + {q}_{0} {q}_{2} ) \\ 2 ( {q}_{1} {q}_{2} + {q}_{0} {q}_{3} ) & {q}_{2}^{2} - {q}_{3}^{2} + {q}_{0}^{2} - {q}_{1}^{2} & 2 ( {q}_{2} {q}_{3} - {q}_{0} {q}_{1} ) \\ 2 ( {q}_{1} {q}_{3} + {q}_{0} {q}_{2} ) & 2 ( {q}_{2} {q}_{3} + {q}_{0} {q}_{1} ) & {q}_{3}^{2} - {q}_{2}^{2} - {q}_{1}^{2} + {q}_{0}^{2}\end{matrix} ]$$
wherein C_{b}ⁿ is a rotation matrix for transforming a carrier coordinate system to a navigation coordinate system,
$${C}_{b}^{n} = ( \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ) = ( \begin{matrix}cos γ cos ψ + sin γ sin ψ sin θ & sin ψ cos θ & sin γ cos ψ - cos γ sin ψ sin θ \\ - cos γ sin ψ + sin γ cos ψ sin θ & cos ψ cos θ & - sin γ sin ψ - cos γ cos ψ sin θ \\ - sin γ cos θ & sin θ & cos γ cos θ\end{matrix} )$$
wherein γ, θ, ψ are a rolling angle, a pitch angle, and the course angle respectively.

6. The method of updating an all-attitude angle of an agricultural machine based on a nine-axis MEMS sensor of claim 5, wherein after the step of data-fusion processing the angle, the velocity, the position information and the course angle of the vehicle by the seven-dimensional EKF filtering model, and updating the motional attitude angle of the vehicle in real time, the following step is performed:
extracting the all-attitude angle of the vehicle from updated motional attitude angle of the vehicle, to determine a value of the all-attitude angle, the all-attitude angle of the vehicle including the pitch angle, the rolling angle and the course angle, wherein,
$$\{ \begin{matrix}{ψ}_{Principal} = arctan ( - \frac{{C}_{12}}{{C}_{22}} ) \\ {θ}_{Principal} = arcsin {C}_{32} \\ {γ}_{Principal} = arctan ( - \frac{{C}_{31}}{{C}_{33}} )\end{matrix}$$
the course angle is:
$$ψ = \{ \begin{matrix}{ψ}_{principle} & \\ {ψ}_{principle} + 360 ° & When {C}_{22} > 0 \{ \begin{matrix}{ψ}_{principle} > 0 \\ {ψ}_{principle} < 0\end{matrix} \\ {ψ}_{principle} + 180 ° & When {C}_{22} < 0\end{matrix}$$
the pitch angle is:
θ=θ_{principle}
the rolling angle is:
$$γ = \{ \begin{matrix}{γ}_{principle} + 180 ° & \\ {γ}_{principle} - 180 ° & When {C}_{33} > 0 \{ \begin{matrix}{γ}_{principle} > 0 \\ {γ}_{principle} < 0\end{matrix} \\ {γ}_{principle} & When {C}_{33} < 0\end{matrix} .$$
